(19) United States
(12) Patent Application Publication
(10) Pub. No.: US 2025/0019035 A1
(43) Pub. Date: Jan. 16, 2025

(54) Drive train with crankset and hub gear

(71) Applicant: Wilfried DONNER, Rech (DE)

(72) Inventor: Wilfried DONNER, Rech (DE)

(21) Appl. No.: 18/708,675

(22) PCT Filed: Nov. 10, 2022
(86) PCT No.: PCT/EP2022/081474

§ 371 Date: May 9, 2024

(30) Foreign Application Priority Data
Nov. 11, 2021 (DE) 10 2021 129 412.6

(51) Int. Cl. B62M 11/18; B62M 6/55

(52) U.S. Cl. CPC B62M 11/18; B62M 6/55

(57) ABSTRACT

A drive train for a vehicle with a pedal drive with a bottom bracket shaft (1) of a crank drive, which comprises a first planetary gear (8, 9, 10) shiftable by clutches, the output of which is connected by a traction means to a rear wheel gearbox comprising a further gearbox shiftable by second clutches, wherein these two gearboxes are each to be shifted in such a correlated manner that gear transitions are approximately the same overall, characterized in that, in a first shift position, the bottom bracket shaft (1) is directly connected on an output side to a traction drive (ZG) by the first planetary gear (8, 9, 10) and/or, in addition, an auxiliary electric motor (EM) is connected by the planetary gear (8, 9, 10) to the traction drive (ZG) and that the gear transition of the first planetary gear (8, 9, 10) comprises each all finer-stepped gear transitions of a further gearbox (NG) arranged downstream via the traction drive (ZG) and/or in a second shift position of the planet carrier clutches and the sun gear wheel clutches (KPT, KSR) of the first gearbox, the auxiliary electric motor (EM) is coupled directly to the output shaft (3) via the reduction gearbox and further the bottom bracket shaft (1) is coupled to the output shaft (3) via this first planetary gear (8, 9, 10).

### 1. TECHNICAL FIELD

The present invention relates to a drive train for a vehicle which is coupled to a pedal drive and/or to an (auxiliary) electric motor on an input side and comprises, at a drive, a first planetary gear which is shiftable by clutches and the output of which is coupled by a traction means to a rear-wheel gearbox comprising a further gearbox which is shiftable by second clutches, wherein the first and second clutches are each to be shifted in such a correlated manner that the gear transitions are approximately equal overall.

### 2. BACKGROUND

Such a drive train is described in DE 10 2018 008 464 A1.

In the prior art, the low gear transitions are generally realized in the first planetary gear and the higher gear transitions in the rear gearbox. An auxiliary electric motor may be connected to a bottom bracket shaft via a gearbox with freewheel protection.

As known, such vehicles are equipped with an auxiliary electric motor that is operated at high speed with a low torque, for which reason a multi-stage reduction gearbox is usually used, the last gear stage of which generates such a high torque that a borderline load may occur.

### 3. PROBLEM TO BE SOLVED

An object of the present invention is to provide a drive train comprising a first planetary gear which is simpler in design than the planetary gear referred to above in that it requires less installation space, in particular less installation width, and is accordingly lighter, and in that it comprises a lower gear load and tractive mean force in operation for the same drive power respectively. Further, any auxiliary electric motor that may be coupled is intended to have such a low reduction ratio that it can be operated at a relatively high speed, thereby achieving a high level of efficiency and a low mass.

### 4. SUMMARY OF THE INVENTION

The object is solved by a drive train for a vehicle according in accordance with the features of independent claim 1. Further advantageous embodiments of the solution are set out in the dependent claims.

The solution is that in a first gearshift position, the input side of the first planetary gear on the crank side, for example the crank drive, is coupled directly to the traction means on the output side and/or an (auxiliary) electric motor is coupled to the traction means via this planetary gear in a reducing manner and that in a second gearshift position of the clutches, the crank drive in the planetary gear is translated into high speed and/or, if applicable, the motor drive is coupled directly to the traction means and that the gear step of this first planetary gear comprises all the finer stepped gear steps of the gearbox connected downstream via the traction means. the motor drive is coupled directly to the traction means and that the gear transition of this first planetary gear comprises all finer stepped gear transitions of the gearbox coupled downstream via the traction means.

An upstream conversion stage of the motor input side is advantageously an angular gear, belt gear or spur gear. Compared to correspondingly used gearboxes in the prior art, a considerably lower torque is transmitted in practical operation due to the further reduction.

In a first embodiment of the crank-side planetary gear, its ring gear is kept rotationally fixed in the crank housing, and the sun gear wheel is rotatably supported centered in the ring gear wheel or housing and may be coupled to an output shaft and thus to a traction drive by means of a controllable sun gear clutch. Alternatively, when the sun gear clutch is open and the planet carrier clutch is closed, the planet carrier is coupled to the output shaft, to which the bottom bracket shaft is connected via a freewheel clutch, which allows backward pedaling, and a crank adapter. The two gearshift positions of the aforementioned clutches are set by axially slidable coupling elements in one or the other direction, whereby they keep each clutch open against spring forces acting in the closing direction of the clutches. The sun gear wheel and the planetary gear wheels are dimensioned in such a way that the gearbox provides a transmission ratio of approximately a factor of 2.5 to 3, whereby each acting engine torque is transmitted directly to the output shaft at the output speed of the planetary gear. In the connected traction drive, which leads to the rear wheel hub, a belt is preferably used to transmit the tractive force, wherein a transmission ratio of the traction drive of approx. 0.75 to 1.5, preferably 1, is provided. In the second gearshift position, the gearbox is ineffective.

The sun gear wheel is appropriately centered with a relatively small ball bearing on the sun gear wheel, from which a centering disc extends to the ring gear wheel, into which it engages with limited axial slidability and next to which it is supported by a spacer sleeve extending to the housing cover.

In a version prepared for coupling to an auxiliary electric motor, the centering ring is rotatably supported in the ring gear wheel, and it engages with the sun gear wheel in an axially slidable manner to a limited extent.

In the version with the auxiliary electric motor, a crown wheel of an angular gear is arranged which, on the one hand, acts as a centering ring and, on the other hand, is a gear element through a ring gear into which a relatively small pinion of the motor drive engages. This described angular gear significantly reduces the engine speed, which is transmitted directly to the output shaft or further reduced in the planetary gear, depending on the position of the sun gear wheel and planet carrier clutches. The angular gear is either a bevel gear or a crown gear.

The number of gears of the rear wheel gearbox may be doubled by switching the clutches mentioned. The transmission ratio of the first planetary gear is selected according to a power of the gear transition of the second planetary gear, the hub gearbox, whose gear transitions are largely constant. The transmission ratio of the first planetary gear is preferably three or slightly lower.

The advantage of this design is that the first planetary gear is always loaded by at most one torque source, resulting in low transmission losses, a lightweight design with few gearwheels and low wear on this gearbox.

The motor is coupled with its reduction gear in such a way that the motor speed is only reduced to about three times the crank speed. In one of the examples given here, the reduction factor is approx. 2.9. This range is filled by the finely stepped gear transitions of the five-, six- or seven-speed hub gearbox installed in each case, resulting in an overall ratio range of approx. 6.87 or 7.1 or 7.2, which meets the usual claims.

Since the first planetary gear on the crank side is used alternatively in each case by converting either the drive torque of the auxiliary electric motor or that of the pedal crank, it is extremely space-saving, so that the auxiliary electric motor with its gearbox is advantageously arranged directly on its planetary gear, which, depending on the gearshift position, drives the output shaft directly or its sun gear wheel to further reduce the speed.

In the drive train, rear wheel hub gearboxes with different ratios, for example 5, 6 or 7 gears, can preferably be used, in which overall gear jump equality with the bottom bracket gearbox is largely apparent and continuous step-up capability is achieved. This can be seen from the three shift tables that form part of this communication, which clearly show the clutch positions of the gears and the number of teeth of the planetary gear gears together with the gear steps.

A 14-speed gearbox is known from EP 0 915 800 B1, which consists of a coupled downstream single planetary gear and a double planetary gear; the latter is a seven-speed gearbox in which the planet carriers are to be connected alternately to an input sleeve or an output sleeve by a clutch. The clutches are pawl clutches which must be disengaged when changing gear.

The new rear wheel hub gearboxes preferably used here correspond approximately to the aforementioned seven-speed gearbox in terms of their width; however, their planet carriers are each firmly coupled to the drive sleeve or the output sleeve. Further, parts of each of the clutches are designed to be axially slidable for the purpose of shifting, whereby they may be shifted under load, as described in the application for a nine-speed transmission DE11 2019 001 604A1.

The two novel planet carriers are supported axially and radially against each other in an inventive manner by means of a ball bearing. This considerably simplifies the assembly of the gearbox and prevents axial or radial misalignment during operation, otherwise meshing faults may occur. The partial gearboxes of the five-, six- or seven-speed gearbox are each designed as mirror images, so that numerous repeat parts can be used for production, which considerably simplifies the creation, tooling and manufacture of these parts as well as their storage.

Furthermore, the ring gear wheel, which is practically just a hollow ring with internal teeth and connects the two mirror-image partial gearboxes, is designed without a wall to save weight and is only guided axially within narrow limits by means of contact surfaces on both sides. Skids on the ring gear wheel, inlets in the housing or guide elements on the web may be used for this purpose.

In DE10 2018 008 464A1, acknowledged at the beginning, the means for continuous indexing and suitable rear wheel hub gearboxes are disclosed. These preferred second planetary gears described there each consist of two partial gearboxes whose input and output are effected via their web or ring gear wheel, wherein the two partial gearboxes are coupled via their webs. DE11 2019 001 604 A1 describes for a nine-speed gearbox that 8 clutches for 9 gears engage in the gearbox. The clutches controlling the ring gear wheels are arranged at a considerable distance from the central axis and guided in separate cylindrical sleeves and are actuated with coupled controls that require high manufacturing accuracy.

According to the invention, the individual gear stages are each selectively controlled by control means, comprising control actuators called control actuators, which control clutches K20, K30, K40, K50, K70, KSR and KHR assigned to the individual gearwheels. The following table shows an assignment of the control states of the individual clutches for gearwheels with exemplary numbers of teeth to gears 1 to 10:

| Gₙ | K20 | K30 | K40 | K50 | K70 | K_{SR} | K_{HR} | iₙ | ${s}_{n} = \frac{{i}_{n}}{{i}_{n + 1}}$ |
|---|---|---|---|---|---|---|---|---|---|
| 1 | 1 | — | — | 1.538 | — | 1 | — | 1.838 | 1.241 |
| 2 | — | 0.806 | — | 1.538 | — | 1 | — | 1.239 | 1.239 |
| 3 | 1 | — | — | — | 1 | 1 | — | 1.000 | 1.241 |
| 4 | — | 0.806 | — | — | 1 | 1 | — | 0.806 | 1.239 |
| 5 | — | — | 0.650 | — | 1 | 1 | — | 0.650 | 1.207 |
| 6 | 1 | — | — | 1.538 | — | — | 0.350 | 0.538 | 1.241 |
| 7 | — | 0.806 | — | 1.538 | — | — | 0.350 | 0.434 | 1.239 |
| 8 | 1 | — | — | — | 1 | — | 0.350 | 0.350 | 1.241 |
| 9 | — | 0.806 | — | — | 1 | — | 0.350 | 0.282 | 1.239 |
| 10 | — | — | 0.650 | — | 1 | — | 0.350 | 0.227 | |

The control actuators may be controlled mechanically, electrically, pneumatically or hydraulically. Electrical control actuators comprise electromagnetic actuators, for example.

Electric control actuators may be used advantageously in e-bikes, for example, because they already have electric control of the input side and the charging cycles and corresponding electric drive energy. Electrically controlled actuators may be connected particularly advantageously to the electrical control of the input side and enable optimum load-dependent control as an electric “automatic gearbox”. This embodiment is not illustrated in more detail.

Pneumatic or hydraulic actuators may comprise controllable pressure cylinders, for example. Pneumatic or hydraulic actuators may be used advantageously in systems in which a pneumatic or hydraulic pressure system is already present, for example to increase the braking effect or to actively dampen shocks. These embodiments are not illustrated in more detail.

A combination of electrical and/or pneumatic and/or hydraulic and/or mechanical control of the actuators is possible at any time. For example, pneumatic or hydraulic control actuators may be controlled electrically via so-called solenoids, as may mechanical slides or a slide ring. The control actuators may be arranged inside or partially outside the drive hub, which comprises the gearbox. For example, a step control may be advantageously mounted inside the drive hub, which, after actuation, moves up or down by one gear step electrically, pneumatically, hydraulically or mechanically in each case.

A purely mechanical control of the actuators is described below as a preferred embodiment.

Thanks to the new gear distribution in the drive train, only one pair of planetary geares is used in each of the various rear wheel hub gearboxes to be installed as an alternative, which significantly reduces the overall width and mass of these rear wheel hubs compared to the previously known ones. The clutches are arranged close to the axles so that only sun gear wheels or planet carriers can be controlled with clutches. Therefore, five clutches are sufficient for a five-speed gearbox and six clutches for a six- or seven-speed gearbox, which simplifies production and shift control. In addition, only one relatively light ring gear wheel, which is common to both planetary geares and has no support walls extending to the axle, is provided.

Gearshift tables for the three gearbox variants are included here. A legend for the information in the tables has been added.
TSG bottom bracket gearbox
IGH hub gear in the rear wheel
HR ring gear wheel
PR planetary gear wheels
SR sun gear wheels
Gₙ gear number
N number of gears
S ratio range
Sₙ Step width between the gears
iₙ conversion ratio
K20, K30, K40 clutches of first partial gearbox of the hub
K50, K60, K70 clutches of second partial gearbox of the hub
KSR sun gear wheel clutch in the bottom bracket gearbox
KHR ring gear wheel clutch in the bottom bracket gearbox

In the upper tables, the number of teeth of the gearwheels that provide an approximately equal step size are shown by way of example.

The lower table shows the specified clutches in their shifting state and the resulting speed conversion. “1” means direct shifting without gear losses. It can also be seen that in the hub gearbox, one direct gear must be shifted in each case and otherwise a maximum of two speed conversions take place, resulting in only low losses.

TABLE 1
2xx5

| | TSG | | IGH | | | | | N = 5 | |
|---|---|---|---|---|---|---|---|---|---|
| HR | −118 | | 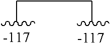 | | | | | $S = \frac{{i}_{1}}{{i}_{2} N} = 6.872$ | |
| PR SR | 28 62 | | 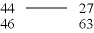 | | | 27 63 | | | |
| i = i ≈ | 0.344 s̅⁽⁻ [symbol] ⁾ | | 0.806 s̅⁽⁻¹⁾ | 0.650 s̅⁽⁻²⁾ | | 1.538 s̅⁽⁻²⁾ | | $\text{?} = \text{?} \sqrt{S} = 1.239$ | |
| Gₙ | KSR | KPT | K20 | K30 | K40 | K50 | K70 | iₙ | $S = \frac{\text{?}}{\text{?}}$ |
| 1 | — | 1 | 1 | — | — | 1.538 | — | 1.538 | 1.241 |
| 2 | — | 1 | — | 0.806 | — | 1.538 | — | 1.239 | 1.239 |
| 3 | — | 1 | 1 | — | — | — | 1 | 1.000 | 1.241 |
| 4 | — | 1 | — | 0.806 | — | — | 1 | 0.806 | 1.239 |
| 5 | — | 1 | — | — | 0.650 | — | 1 | 0.650 | 1.227 |
| 6 | 0.344 | — | 1 | — | — | 1.638 | — | 0.530 | 1.241 |
| 7 | 0.344 | — | — | 0.806 | — | 1.538 | — | 0.427 | 1.239 |
| 8 | 0.344 | — | 1 | — | — | — | 1 | 0.344 | 1.241 |
| 9 | 0.344 | — | — | 0.806 | — | — | 1 | 0.277 | 1.239 |
| 10 | 0.344 | — | — | — | 0.650 | — | 1 | 0.224 | |

[symbol]

indicates data missing or illegible when filed

TABLE 2
2xx6

| | TSG | IGH | | | | N = 6 |
|---|---|---|---|---|---|---|
| HR | −118 | 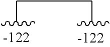 | | | | $S = \frac{i \text{?}}{i \text{?}} = 7.087$ |
| PR SR | 28 62 | 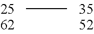 | | 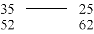 | | |
| i = i ≈ | 0.344 s̅⁽⁻ [symbol] ⁾ | 0.584 s̅⁽⁻³⁾ | 0.701 s̅⁽⁻²⁾ | 1.426 s̅⁽⁻²⁾ | 1.711 s̅⁽⁻²⁾ | $\text{?} = \text{?} \sqrt{S} = 1.195$ |

| | | | | | | | | | | |
|---|---|---|---|---|---|---|---|---|---|---|
| Gₙ | KSR | KPT | K20 | K30 | K40 | K50 | K60 | K70 | iₙ | ${s}_{n} = \frac{{i}_{n}}{{i}_{n + 1}}$ |
| 1 | — | 1 | 1 | — | — | — | 1.711 | — | 1.711 | 1.200 |
| 2 | — | 1 | 1 | — | — | 1.426 | — | — | 1.426 | 1.189 |
| 3 | — | 1 | — | — | 0.701 | — | 1.711 | — | 1.200 | 1.200 |
| 4 | — | 1 | 1 | — | — | — | — | 1 | 1.000 | 1.200 |
| 5 | — | 1 | — | 0.584 | — | 1.426 | — | — | 0.833 | 1.180 |
| 6 | — | 1 | — | — | 0.701 | — | — | 1 | 0.701 | 1.189 |
| 7 | 0.344 | — | 1 | — | — | — | 1.711 | — | 0.590 | 1.200 |
| 8 | 0.344 | — | 1 | — | — | 1.426 | — | — | 0.491 | 1.189 |
| 9 | 0.344 | — | — | — | 0.701 | — | 1.711 | — | 0.413 | 1.200 |
| 10 | 0.344 | — | 1 | — | — | — | — | 1 | 0.344 | 1.200 |
| 11 | 0.344 | — | — | 0.584 | — | 1.426 | — | — | 1.287 | 1.189 |
| 12 | 0.344 | — | — | — | 0.701 | — | — | 1 | 0.242 | |

[symbol]

indicates data missing or illegible when filed

TABLE 3
2xx7

| | TSG | IGH | | | | N = 7 |
|---|---|---|---|---|---|---|
| HR | −118 | 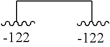 | | | | $S = \frac{{i}_{1}}{{i}_{2 N}} = 7.191$ |
| PR SR | 28 62 | 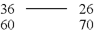 | | 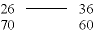 | | |
| i = i ≈ | 0.344 s̅⁽⁻ [symbol] ⁾ | 0.738 s̅⁽⁻³⁾ | 0.635 s̅⁽⁻²⁾ | 1.574 s̅⁽⁻²⁾ | 1.355 s̅⁽⁻²⁾ | $\text{?} = \text{?} \sqrt{S} = 1.164$ |

| | | | | | | | | | | |
|---|---|---|---|---|---|---|---|---|---|---|
| Gₙ | KSR | KPT | K20 | K30 | K40 | K50 | K60 | K70 | iₙ | $S \text{?} = \frac{{i}_{n}}{{i}_{n + 1}}$ |
| 1 | — | 1 | 1 | — | — | 1.574 | — | — | 1.574 | 1.161 |
| 2 | — | 1 | 1 | — | — | — | 1.355 | — | 1.355 | 1.167 |
| 3 | — | 1 | — | 0.738 | — | 1.574 | — | — | 1.161 | 1.161 |
| 4 | — | 1 | 1 | — | — | — | — | 1 | 1.000 | 1.161 |
| 5 | — | 1 | — | — | 0.635 | — | 1.355 | — | 0.861 | 1.167 |
| 6 | — | 1 | — | 0.738 | — | — | — | 1 | 0.738 | 1.161 |
| 7 | — | 1 | — | — | 0.635 | — | — | 1 | 0.635 | 1.172 |
| 8 | 0.344 | — | 1 | — | — | 1.574 | — | — | 0.542 | 1.161 |
| 9 | 0.344 | — | 1 | — | — | — | 1.355 | — | 0.467 | 1.167 |
| 10 | 0.344 | — | — | 0.738 | — | 1.574 | — | — | 0.400 | 1.161 |
| 11 | 0.344 | — | 1 | — | — | — | — | 1 | 0.344 | 1.161 |
| 12 | 0.344 | — | — | — | 0.635 | — | 1.355 | — | 0.297 | 1.167 |
| 13 | 0.344 | — | — | 0.738 | — | — | — | 1 | 0.254 | 1.161 |
| 14 | 0.344 | — | — | — | 0.635 | — | — | 1 | 0.219 | |

[symbol]

indicates data missing or illegible when filed

### 5. BRIEF DESCRIPTION OF THE DRAWINGS

In the following, embodiments of the invention are described with reference to figures. These figures show:

FIG. 1: a bottom bracket with shiftable planetary gear.

FIG. 2: a bottom bracket as shown in FIG. 1 with ring gear bearing.

FIG. 3: a bottom bracket as shown in FIG. 2 with motor and angular gear.

FIG. 4: A bottom bracket as shown in FIG. 3 with planetary gear reducing the motor speed.

FIG. 5: A bottom bracket as shown in FIG. 3 with a planetary gear reducing the pedal speed.

FIG. 6a: a fixed ring with control grooves.

FIG. 6b: perspective view of a gearshift assembly with quadrant section.

FIG. 6c: a 5-speed gearshift drum gearbox.

FIG. 6d: a gearshift drum winding 11-, 12-, 13-speed gearbox.

FIG. 7: a 5-speed hub gearbox.

FIG. 8: a 6-speed hub gearbox.

FIG. 9: a 7-speed hub gear.

FIG. 10: a schematic diagram of an arrangement of the traction drive ZG, the rear wheel hub gear NG and the control means.

FIG. 11: a schematic diagram of an arrangement of the traction drive ZG, the rear wheel hub gear NG and the effect of the control means on individual clutches.

The gearboxes are illustrated schematically in a radial half section.

### 6. DETAILED DESCRIPTION

Embodiments of the present invention are described below by way of example only. These examples illustrate the best ways of putting the invention into practice that are currently known to the application, although of course these are not the only ways in which this may be achieved. The description sets out the functions of the example and the sequence of steps for designing and operating the example. However, the same or equivalent functions and sequences may be achieved by other examples.

Identical components comprise the same reference signs.

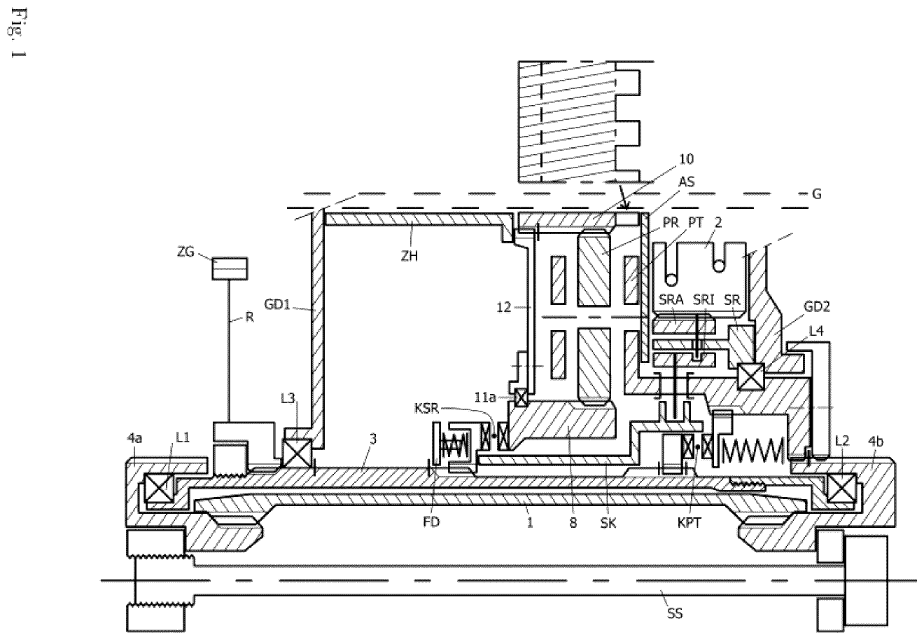

FIG. 1 shows a version without motor drive. A bottom bracket shaft 1 is mounted on both sides with crank adapters 4a, 4b, pulled together by a tensioning screw

SS, in an output shaft 3 at its two ends with rolling bearings L1, L2 by engaging under the latter. These roller bearings L1, L2 are advantageously arranged approximately in the cams, so that only low bending forces occur in the bottom bracket shaft 1. The output shaft 3 is mounted on the outside of each side by means of further rolling bearings L3, L4 in housing covers GD1, GD2 of a gearbox housing G, which are only partially illustrated. The output shaft 3 carries a chain or belt wheel, also called a pinion R, of a traction drive ZG at one end. Two clutch parts are arranged on the output shaft 3, each fixed against rotation, namely that of a planetary carrier clutch KPT and that of a sun gear clutch KSR. The input side part of the planet carrier clutch KPT connects the planet carrier 7 to the input shaft 3, wherein the clutch part coupled to the output shaft 3 is also axially fixed and wherein the output side sun gear wheel clutch KSR connects the sun gear wheel 8 to the output shaft 3 via an axially slidable clutch part.

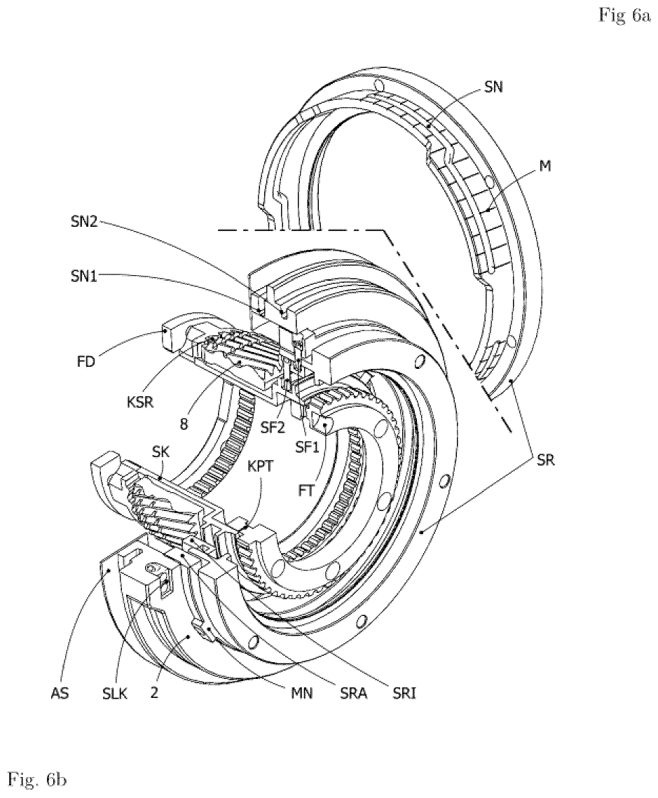

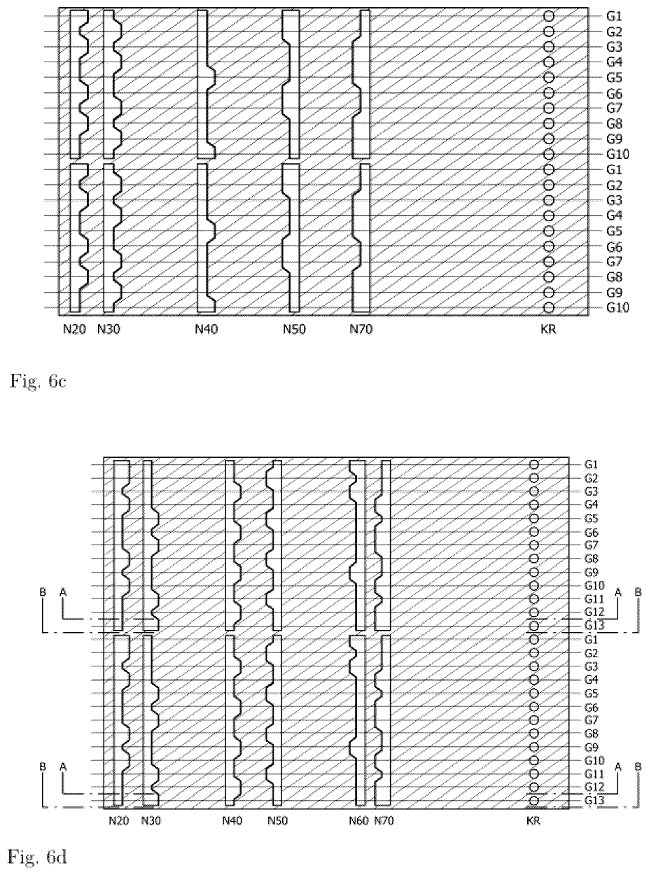

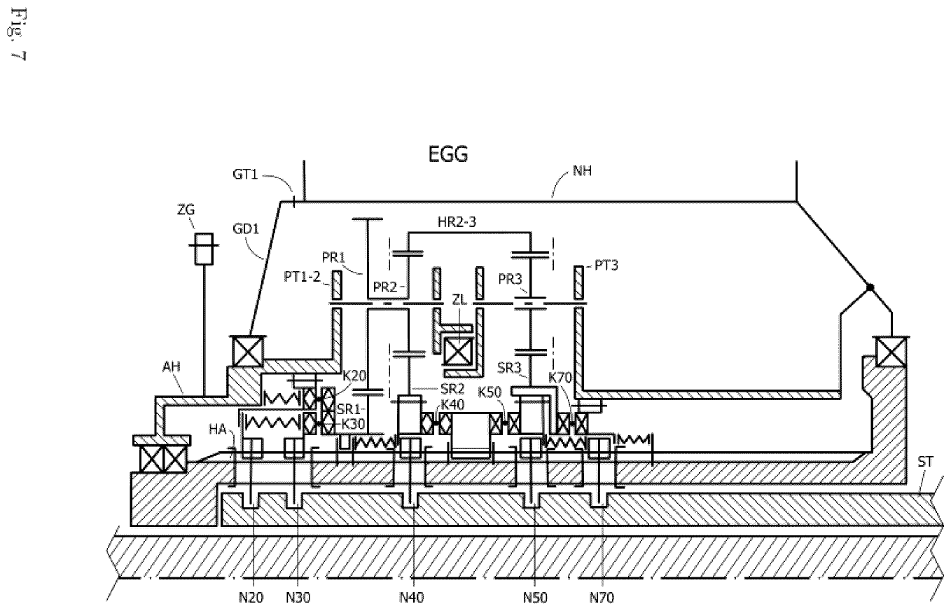

FIG. 6a shows a section of a ring FR fixed to the housing, pulled out and rotated by 90, with 3 gear shifting grooves, each offset by 120, which each run in two axially offset, coupled paths that cause the two gear groups to be reversed when the corresponding components are rotated.

FIG. 6b shows the entire gear shifting assembly with the sun gear clutch KSR and the planetary carrier clutch KPT, the cut side of which can be seen in the section. The two clutches are switched alternately with the shift gate SK, which runs coaxially through the sun gear wheel 8. Spring pockets FT are arranged in the clutches, each equipped with compression springs that act in the closing direction of the clutches. The cylindrical mandrels on the spring mandrel rings FD serve to securely guide the compression springs, which in turn plunge into the spring pockets FT.

Cable grooves SN1, SN2 with different diameters adapted to the conditions for gear shifting cables leading to a gear adjustment handle or to a rear wheel hub gearbox are provided in the shifting cable pulley 2. In addition, chambers for cable clamps SLK are incorporated into the shifting cable pulley 2 for easy access for adjustment purposes. The shifting cable pulley is axially slidable within narrow limits for tolerance compensation; a thrust washer AS limits the freedom on one side by means of a stop against the ring gear wheel 10.

In the shifting cable pulley 2, an outer shifting ring SRA is axially coupled by a driver MN, which is arranged on a ring FR fixed to the housing, in which an inner shifting ring SRI is arranged, which is coupled to first shifting fingers SF1 through the gear shifting grooves in the fixed ring FR to the outer shifting ring SRA in an axially slidable manner. Second switching fingers SF2 lead from the latter into a circumferential groove in the switching gate SK. In this way, when the shifting cable pulley 2 is rotated, the axial offset of the gear shifting grooves SN is transferred to the shifting gate SK in each case.

FIG. 6c shows the unwinding of the control grooves N2, N3, N4, N5, N7 in the gear shifting drum ST of a five-speed hub gearbox to the individual gear positions G1-G5 of a coupled latching shift ring.

FIG. 6d shows a shift drum unwinding in an 11-, 12-, 13-speed gearbox.

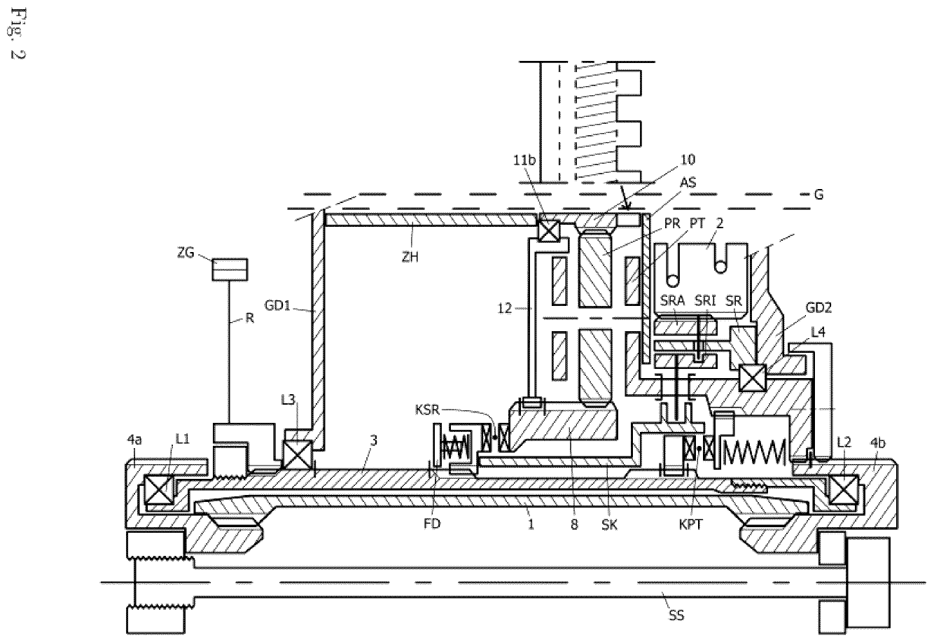

FIG. 2 shows a centering bearing 11 in the ring gear wheel 10, from which a centering ring 12 extends to the sun gear wheel 8, on which it is axially slidable with a small axial play limited area and is kept rotationally fixed. A centering sleeve ZH extends from the centering bearing 11 to the housing G.

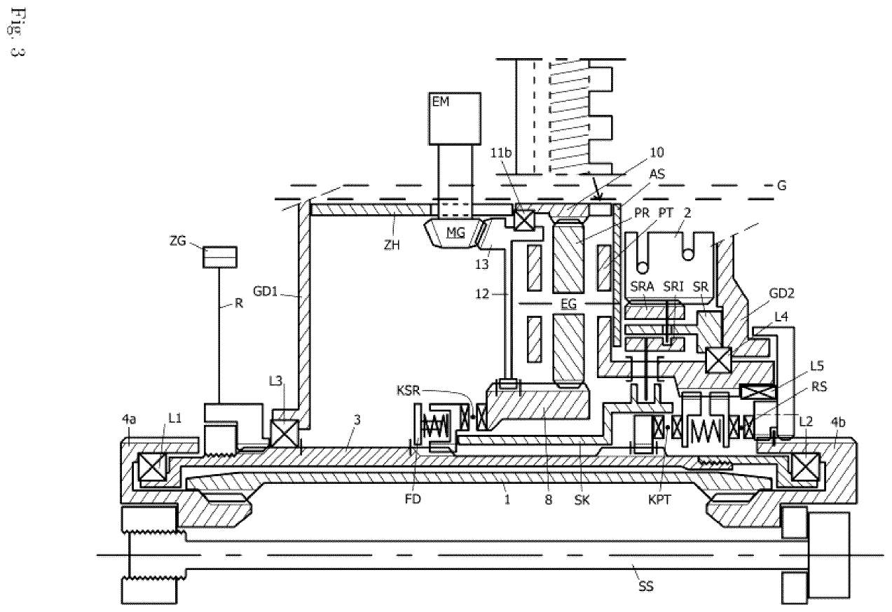

FIG. 3 shows the bottom bracket gearbox with an auxiliary electric motor EM connected to it. The electric motor EM of the drive module is coupled on the output side to the sun gear wheel 8 by means of a reduction motor gear MG, the output side of which carries the second half of the sun gear wheel clutch KSR. In this example, the motor gearbox is formed by a crown wheel 13 with a bevel gear rim on the edge, which is arranged next to the centering bearing 11, and a smaller bevel gear on the motor shaft that engages in the bevel gear rim. The described clutches KSR, KPT are each switched in such a way that one is alternatively closed and the other is open or vice versa. As a result, the reduced engine speed is coupled to the output shaft 3 either directly or further reduced by the planetary gear. The planetary carrier clutch KPT runs through a freewheeling mode each time it opens due to a suitable spread.

In the first gear stage of the input planetary gear EG, namely the bottom bracket gearbox, the planetary carrier clutch KPT is closed, so that a crank torque is transmitted directly to the output shaft 3 in each case, wherein the sun gear wheel clutch KSR is open. The engaged electric motor EM then drives the sun gear wheel 8 of the input planetary gear EG and reduces the engine speed. the motor speed to the crank speed in each case. As the planet carrier 7 is coupled to the bottom bracket shaft 1 in a rotationally fixed manner, the engine torque is also transmitted to the output shaft 3 via the closed planet carrier coupling KPT. In this way, the low gear stages of the drive train are realized.

In the second gear stage of the input planetary gear EG, the planetary carrier clutch KPT is open, so that the crank speed is transmitted via the input planetary gear EG to the high speed present at the sun gear wheel 8. The sun gear wheel clutch KSR is closed, so that the engine torque and the reduced crank torque are transmitted to the output shaft 3 via the sun gear wheel clutch KSR. The entire torque is therefore transmitted to the rear wheel hub gear NG via the traction drive ZG with the pinion Z at a significantly higher speed and thus with a correspondingly reduced force. In this way, the upper half of the gear stages of the drive train is realized.

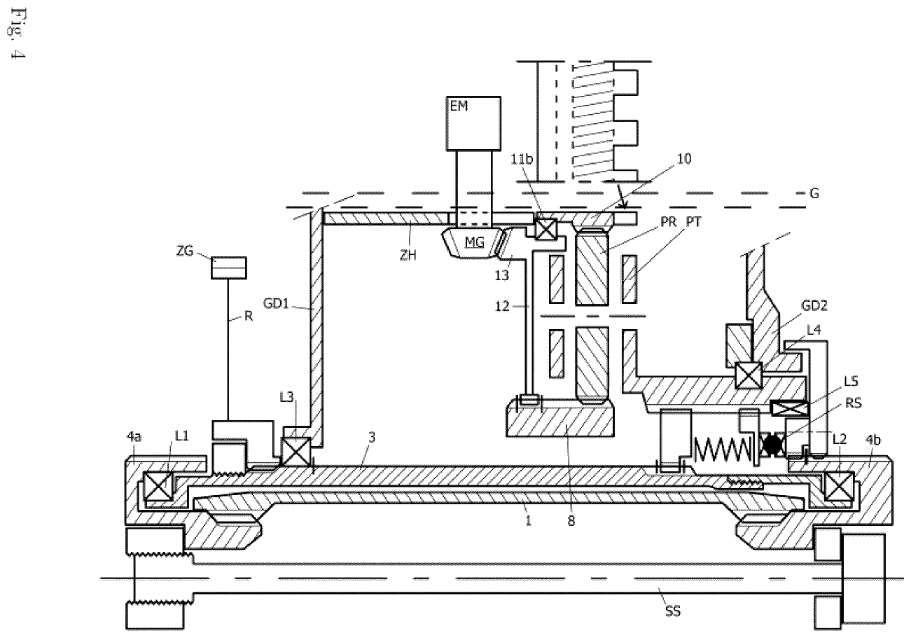

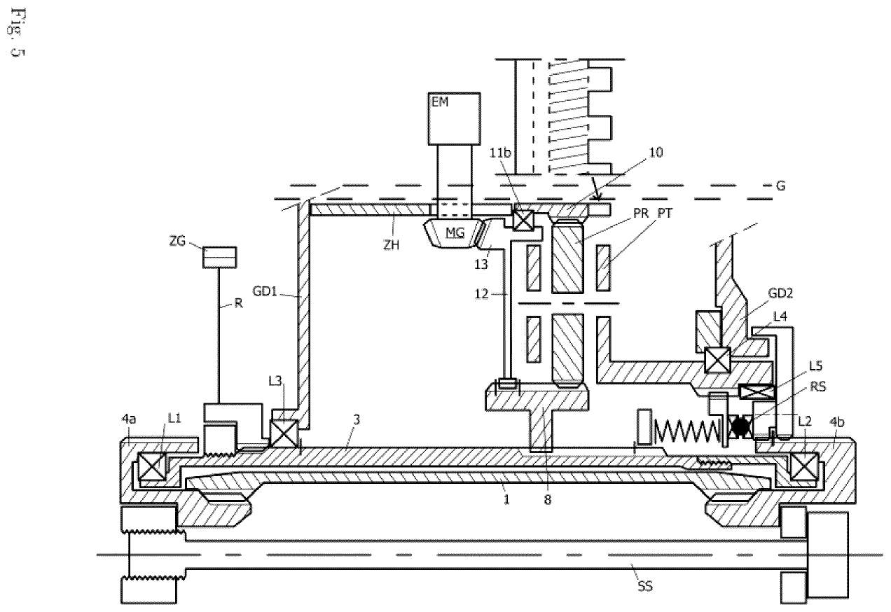

The advantages of the invention include the fact that, depending on the shifting state of the first planetary gear EG, it never serves as a reduction gearbox, FIG. 4, for the electric motor drive or otherwise serves as a transmission gearbox, FIG. 5, for the crank drive, wherein both torques of the two drive means are never transmitted simultaneously by this planetary gear, which results in lower transmission losses and a lighter construction and less wear of this gearbox. The simplified embodiments according to FIGS. 4 and 5 are shown without the clutches and their control means required for a changeover. In these examples, only the first or second half of each of the shift tables has been realized. The clutch illustrated is a backstop RS, which provides a freewheel function that enables backward pedaling, which is also illustrated in the other figures of the bottom bracket gearbox.

The particularly favorable combinations of a bottom bracket gearbox and a rear wheel hub gearbox of the type described here, which matches the gear gradation and can be controlled in a coordinated manner, shown in the tables above, are preferred objects of protection; however, the described gearbox assemblies on the bottom bracket side and the rear wheel hub side also illustrate independent commercial objects worthy of protection due to their new and inventive design and properties, which may also be used in each case without a second gearbox or in combination with differently designed rear wheel or bottom bracket gearboxes. The stepping of the gears when used without a further overlapping gearbox, which doubles the number of gear stages, is advantageously implemented with a seven- or five-speed gearbox with a larger spread by selecting the gear pairs differently, as shown in the following Tables 4a and 4b.

The dependent claims cover these details.

TABLE 4a
1xx7

| | IGH | | | | N = 7 |
|---|---|---|---|---|---|
| HR | 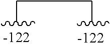 | | | | $S = \frac{{i}_{1}}{{i}_{N}} = 3.354$ |
| PR SR | 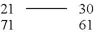 | | 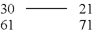 | | |
| i = i ≈ | 0.546 s̅⁽⁻³⁾ | 0.667 s̅⁽⁻³⁾ | 1.500 s̅⁽⁺²⁾ | 1.831 s̅⁽⁺³⁾ | $\overline{s} = \text{?} \sqrt{S} = 1.223$ |

| | | | | | | | | |
|---|---|---|---|---|---|---|---|---|
| Gₙ | K20 | K30 | K40 | K50 | K60 | K70 | iₙ | ${s}_{n} = \frac{{i}_{n}}{{i}_{n + 1}}$ |
| 1 | 1 | — | — | — | 1.831 | — | 1.831 | 1.221 |
| 2 | 1 | — | — | 1.500 | — | — | 1.500 | 1.229 |
| 3 | — | — | 0.667 | — | 1.831 | — | 1.221 | 1.221 |
| 4 | 1 | — | — | — | — | 1 | 1.000 | 1.221 |
| 5 | — | 0.546 | — | 1.500 | — | — | 0.819 | 1.229 |
| 6 | — | — | 0.667 | — | — | 1 | 0.667 | 1.221 |
| 7 | — | 0.546 | — | — | — | 1 | 0.546 | |

$\text{?} \text{indicates text missing or illegible when filed}$

TABLE 4b
1xx5

| | IGH | | N = 5 |
|---|---|---|---|
| HR | | 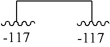 | $S = \frac{{i}_{1}}{{i}_{N}} = 2.527$ |

| | | |
|---|---|---|
| PR SR | 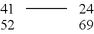 | 24 69 |

| | | | | |
|---|---|---|---|---|
| i = i ≈ | 0.794 s̅⁽⁻¹⁾ | 0.629 s̅⁽⁻²⁾ | 1.590 s̅⁽⁺²⁾ | $\overline{s} = \text{?} \sqrt{S} = 1.261$ |

| | | | | | | | |
|---|---|---|---|---|---|---|---|
| Gₙ | K20 | K30 | K40 | K50 | K70 | iₙ | $s \text{?} = \frac{{i}_{n}}{{i}_{n + 1}}$ |
| 1 | 1 | — | — | 1.590 | — | 1.590 | 1.260 |
| 2 | — | 0.794 | — | 1.590 | — | 1.262 | 1.262 |
| 3 | 1 | — | — | — | 1 | 1.000 | 1.260 |
| 4 | — | 0.794 | — | — | 1 | 1.000 | 1.262 |
| 5 | — | — | 0.620 | — | 1 | 0.629 | |

$\text{?} \text{indicates text missing or illegible when filed}$

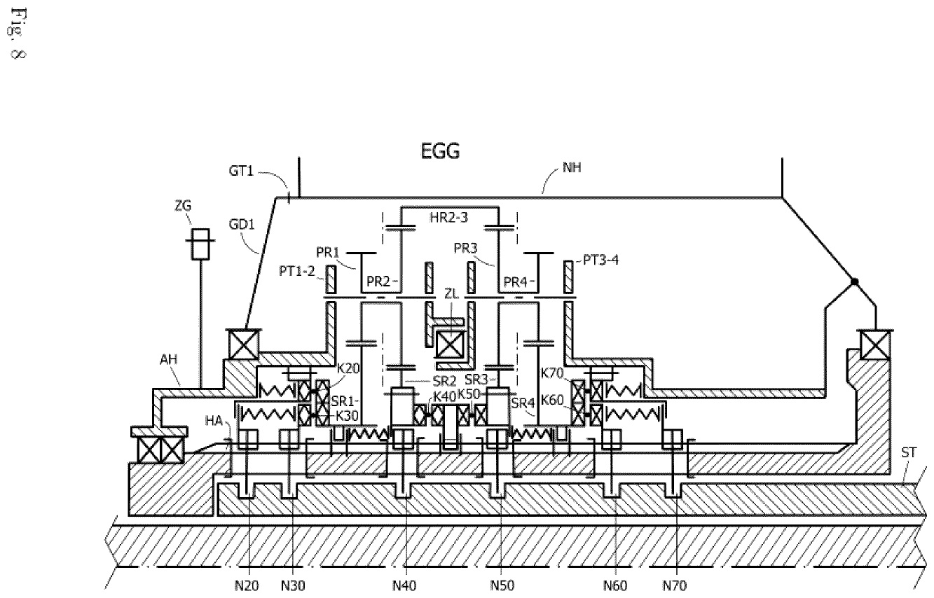

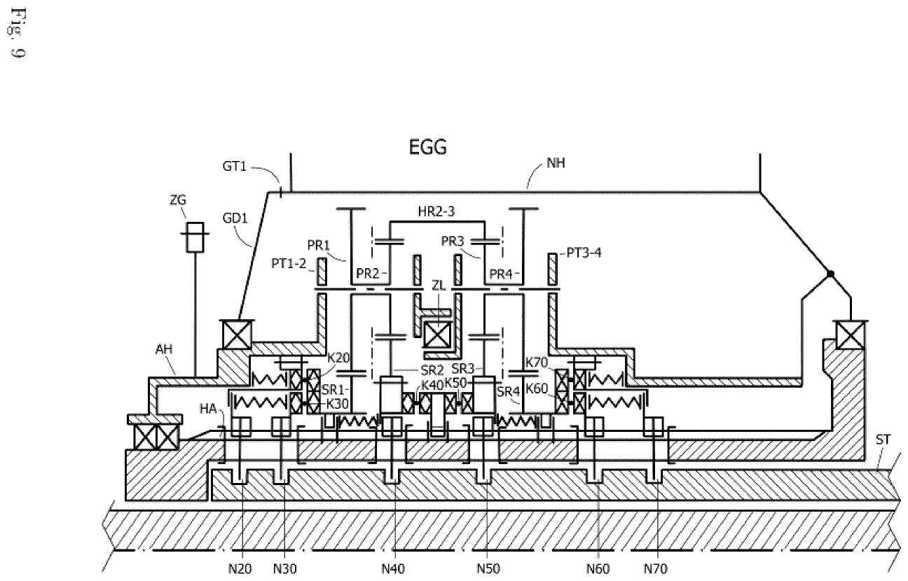

FIGS. 7 to 9 show suitably stepped rear wheel hub gears. In a preferred embodiment, the traction drive ZG is equipped with a belt and the rear wheel hub gear is a five-speed gear, six-speed gear or seven-speed gear, which requires relatively little width. These gearboxes generally comprise two mirror-image planetary geares, the planet carriers PT1-2 or PT3-4 of which are firmly coupled to an input sleeve AH or an output sleeve, namely the hub sleeve NH, and the sun gear wheels SR1-SR4 of which are to be coupled with associated clutches (20, 30, . . . 70) close to the axles, each either to a main axis HA or alternatively to one of the planet carriers PT1-2 or PT3-4 on the input or output side in a controlled manner.

The planet carriers of the two gearboxes are coupled axially and radially in a non-positive manner to a free central bearing ZL. The ring gear wheels HR2-3 of both planetary geares are firmly coupled together and limited in their axial freedom by stop surfaces.

The clutches are controlled in the same way as the embodiment described in DE 11 2019 604 A1, with a grooved gear shifting drum ST at one end of which a cable pulley is attached, which can be rotated into the individual gear settings by means of a cable pull. Other step-by-step twisting devices, e.g. with at least one magnetic armature and possibly with a pawl control, can also be used here. At least two shift fingers of axially movable clutch disks engage in each of the control grooves machined into the gear shifting drum ST. In a first preferred embodiment, control grooves are formed on 180° of the circumference of the gear shifting drum ST for all gears to be shifted, as illustrated by way of example in FIGS. 6c and 6d. In FIG. 6d, the marking AA indicates that only 12 of the possible 13 gears are shifted, which enables a smaller shift drum diameter. The marking BB comprises all 13 gears. This embodiment also allows the further 5-, 6- and 7-speed single-speed transmissions described in the parallel application (rear wheel hub with multi-speed transmission) to be used directly as downshift transmissions in all variants.

In a preferred second embodiment, all 2×N gears to be shifted are formed at two times 120° on the shift drum, wherein a third formation of the gear shifting grooves of the N gears also takes place on the third 120° of the shift drum circumference. The grooves are then formed continuously all the way around, so that all gears are shifted with a 2/3 rotation, wherein the axially movable control elements are each three shift fingers offset by 120°, so that axial displacement of the axially slidable clutch parts is secured against jamming. Over-shifting from G2N to G1 is prevented by at least one separate stop groove, which allows the shift drum to rotate through 240°; it is therefore not possible to shift directly from the highest gear to the lowest gear. If, in particular, two stop grooves are used, these are axially offset so that they do not overlap and are equally distributed in a circular manner. A suitable component for holding the stop pins is the fixed part of the clutch K40/K50. This variant does not require an additional component for the stop pins. The advantage of the second preferred variant is that the gear shifting drum and thus also the main axis surrounding it may be smaller and lighter in diameter than in a 180 degree version and there is sufficient transition space for the shift function of the shift fingers.

The gear ratios of the three optional downshift gearboxes combined with the two bottom bracket settings are shown in the tables above, as are the numbers of teeth of the various sun gear wheels, planetary gear wheels and ring gear wheels of the three exemplary hub designs and the gear ratios that are apparent. The other tables of the variants are shown in the parallel application (rear wheel hub with multi-speed gearbox) as the input gearbox, which is expressly declared here to be part of the subject-matter of the disclosure. This illustrates an even larger selection of step sizes and transmission ratio ranges which may be usefully employed in different conditions.

The number of different gear types and the number of different designs of the clutches close to the axis for actuating the sun gears or planet carriers are small, which favors rational production and warehousing. The availability of the different versions may generally be modified to meet demand due to the modular system.

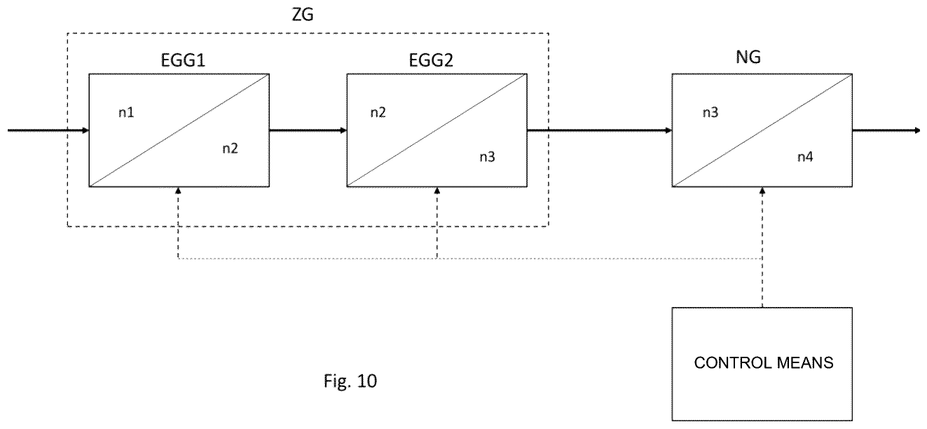

FIG. 10 shows a schematic diagram of an arrangement of the traction drive ZG, the rear wheel hub gear NG and the control means.

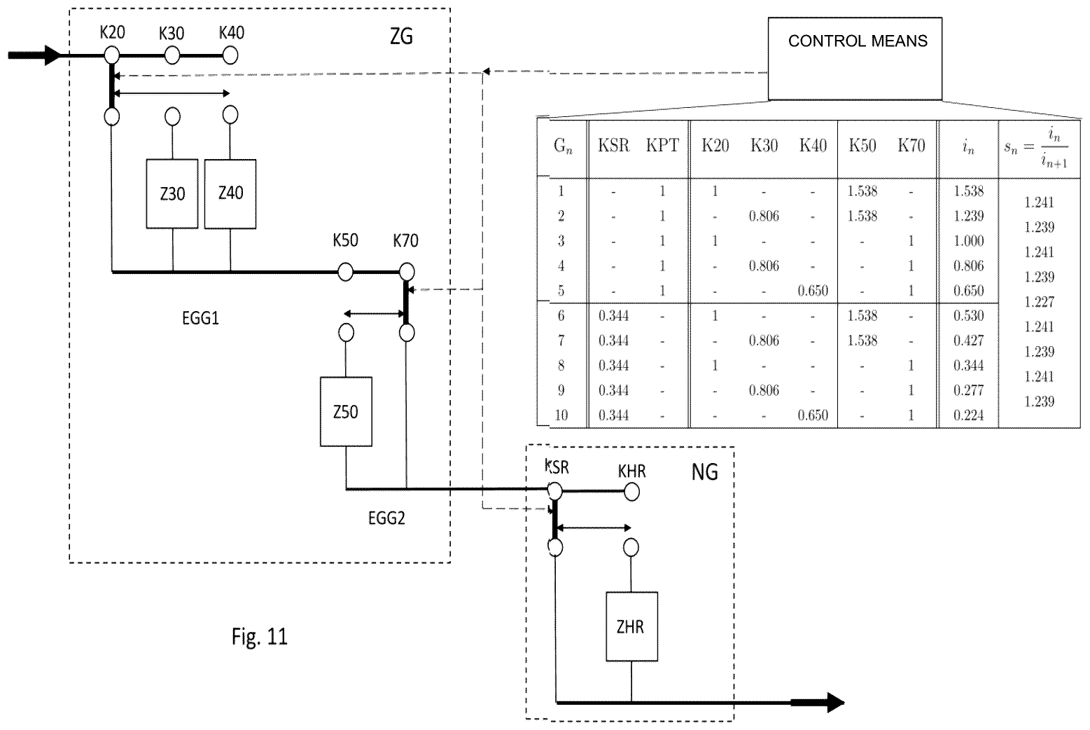

FIG. 11 shows a schematic diagram of an arrangement of the traction drive ZG, the rear wheel hub gear NG and the effect of the control means on individual clutches.

The list of reference signs refers to the attached figures.

| | | | |
|---|---|---|---|
| 1 | bottom bracket shaft | | |
| 2 | shifting cable pulley | SN | gear shifting groove |
| 3 | output shaft | RS | backstop (freewheel function) |
| 4a, 4b | crank adapter | | |
| KPT | planet carrier clutch | | |
| KSR | sun gear wheel clutch | | |
| 7 | planet carrier | | |
| 8 | sun gear wheel | | |
| 9 | planet gear | | |
| 10 | ring gear wheel | HL | ring gear wheel bearing |
| 11 | centering bearing | ZH | centering sleeve |
| 12 | centering ring | | |
| 13 | crown wheel | | |
| EC | input planetary gear | | |
| EM | electric auxiliary motor | MG | motor gearbox |
| G | housing | GD1, GD2 | housing cover |
| L1-L4 | rolling bearing | GT1 | housing separation of |
| | | | GD1 |
| SN | control grooves | | |
| SLK | cable clamp | | |
| AS | thrust washer | | |
| FD | spring mandrel ring | FT | spring pockets |
| RST | ring with fixed control grooves | | |
| SRA | outer gear shift ring | SRI | inner gear shift ring |
| MN | driver from 2 to SRA | | |
| SF1 | gear shift finger from SRA through SF to SRI | | |
| SF2 | gear shift finger from SRI to SK | | |
| SK | gear shifting gate | SSN1, SSN2 | gear shifting cable grooves |
| | | | in 2 |
| FR | fixed ring with FT | | |
| NG | rear wheel hub gearbox | | |
| R | sprocket for belt or chain | SS | tensioning screw |
| ZG | traction drive | ZL | centering bearing |
| HA | main axis | NH | hub sleeve |
| ST | gear shifting drum | | |
| SR1-SR4 | sun gear wheels in the hub gearbox | | |
| PT1-2, PT3-4 | planet carrier in the hub gearbox | | |
| PR1-PR3 | planetary gear wheels | | |
| HR2-3 | ring gear wheel in the hub gearbox | | |
| N20-N70 | gear shifting grooves | | |

1. A drive train for a vehicle with a pedal drive with a bottom bracket shaft (1) of a crank drive, which comprises a first planetary gear (8, 9, 10) shiftable by clutches, the output of which is connected by a traction means to a rear wheel gearbox comprising a further gearbox shiftable by second clutches, wherein these two gearboxes are each to be shifted in such a correlated manner that gear transitions are approximately equal overall, characterized in that, in a first shift position, the bottom bracket shaft (1) is directly connected on an output side to a traction drive (ZG) by the first planetary gear (8, 9, 10) and/or, in addition, an auxiliary electric motor (EM) is connected by the planetary gear (8, 9, 10) to the traction drive (ZG) and that the gear transition of the first planetary gear (8, 9, 10) comprises each all finer-stepped gear transitions of a further gearbox (NG) arranged downstream via the traction drive (ZG) and/or in a second shift position of the planet carrier clutches and the sun gear wheel clutches (KPT, KSR) of the first gearbox, the auxiliary electric motor (EM) is coupled directly to the output shaft (3) via the reduction gearbox and further the bottom bracket shaft (1) is coupled to the output shaft (3) via this first planetary gear (8, 9, 10).

2. The drive train of claim 1, characterized in that a final gear stage of the motor-driven reduction gearbox is a planetary gear (8, 9, 10) comprising an angle drive, a belt drive or a spur gear drive on the input side of the first planetary gear (8, 9, 10), which drive has a rotationally fixed connection to the sun gear wheel (8) of this planetary gear (8, 9, 10).

3. The drive train of claim 2, characterized in that a ring gear wheel (13) of the angle drive, the driven spur gear of the spur gear drive or the driven belt wheel of the belt drive is arranged centered in the ring gear wheel (10) or housing (G) of the first planetary gear (8, 9, 10) by a rolling bearing (11).

4. The drive train of claim 2, characterized in that the first planetary gear (8, 9, 10), in a first statically closed mode of a planet carrier clutch (KPT) of the first planetary gear (8, 9, 10), adapts a speed of a motor drive unit to a reduction of a respective crank speed, wherein the sun gear wheel clutch is omitted.

5. The drive train of claim 4, characterized in that the speed of the motor drive unit is reduced by a factor of three or slightly less in the first planetary gear (8, 9, 10).

6. The drive train of claim 1 or 2, characterized in that the first planetary gear (8, 9, 10) in a second statically closed clutch mode connects a crank speed increased by a factor of approx. 2.5 to 3 to the output shaft (3) and, in addition, the motor with the reduction planetary gear (8, 9, 10) is directly coupled to the output shaft (3) by a closed sun gear wheel clutch (KSR), wherein the traction drive (ZG) is connected to the rear wheel hub gearbox (NG) with a transmission ratio of approx. 0.75 to 1.5, preferably 1, wherein the web clutch is omitted.

7. The drive train of claim 1, characterized in that a belt or a chain is the traction means of the traction drive (ZG) and this forms an intermediate gearbox.

8. The drive train of claim 1, characterized in that the drive train comprises a further gearbox shiftable by second clutches, wherein the first and second clutches are each to be switched in such a correlated manner that gear transitions are approximately the same overall, wherein a first adjustable circulating cable is guided from a rotary control handle to a shifting cable pulley (2) for adjusting the clutches in the bottom bracket gearbox and from this a second adjustable circulating cable leads to the rear wheel hub gearbox (NG).

9. A drive train, in particular according to one of the preceding claims, characterized in that the downstream further gearbox, the rear wheel hub gearbox (NG), consists of two coupled planetary geares (8, 9, 10) one of which is connected by its planet carrier (PT1-2) to the traction drive (ZG) and the second of which is connected by its planet carrier (PT3, PT3-4) to a hub sleeve (NH) and the ring gear wheels (HR2-3) of both planetary geares (8, 9, 10) are fixedly connected and axially secured in position by lateral stops and the planet carriers (PT3, PT3-4) of both planetary geares (8, 9, 10) are axially and radially non-positively connected to a free centering bearing (ZL) and the couplings (K20, K30, . . . , K70) control the sun gear wheels (SR1 -SR4) or the planet carriers (PT1-2, PT3-4), wherein their respective gears are to be set in suitable shift combinations for a five-speed gearbox with 5 clutches (K20, K30, K40, K50, K70) or for a six- or seven-speed gearbox with 6 clutches (K20, K30, K40, K50, K60, K70).

10. The drive train of claim 9, characterized in that the five-speed gearbox consists of a two-stage and a single-stage planetary gear (8, 9, 10), in which the sun gear wheel (SR1) on the input side of the two-stage planetary gear (8, 9, 10) is to be coupled to the driving sleeve (AH) with a first clutch (K20) and alternatively is to be coupled to a main axis (HA) with a second clutch (K30) and that a third clutch (K40) couples the further sun gear wheel (SR2) of the two-stage planetary gear (8, 9, 10) closed to the main axis (HA) and a fourth clutch (K60) couples the sun gear wheel (SR3) of the single-stage planetary gear (8, 9, 10) to the main axis (HA) and a fifth clutch (K70) alternatively couples it to the hub sleeve (NH).

11. The drive train of claim 9, characterized in that the six-speed gearbox and the seven-speed gearbox each consists of two two-stage planetary geares (8, 9, 10) arranged in a mirror-inverted manner and, in the case of the six-speed gearbox, relatively large sun gear wheels (SR1, SR4) and correspondingly smaller planetary gears (PT1, PT4) are arranged on the input and output sides, and the sun gear wheel (SR1) on the input side is to be alternatively coupled to the drive sleeve (AH) or the main axis (HA) by two clutches (K20, K30) and the sun gear wheel (SR4) on the output side is to be alternatively coupled indirectly to the drive sleeve (AH) or the main axis (HA) by two further clutches (K60, K70) to the hub sleeve (NH) or the main axis (HA) and the two adjacent sun gear wheels (SR2, SR3) are each to be coupled to the main axis (HA) by two further clutches (K40, K50) and, in the seven-speed gearbox, smaller sun gear wheels (SR1, SR4) and correspondingly larger planetary gears (PR1, PR4) are arranged in reverse order, wherein the planets and sun gear wheels belonging to one another comprise matching diameters and numbers of teeth with respect to the ring gear wheels (HR2-3).

12. The drive train of claim 10 or 11, characterized in that, in the sequence from the input to the output, the numbers of teeth of the sun gear wheels to the planetary gear wheels and the ring gear wheels (HR2-3) in the case of the five-speed gearbox are: 46/44, 63/27, 63/27, −117 for the six-speed gearbox: 62/25, 52/35, 52/35, 62/25, −122 and for the seven-speed gearbox: 60/36, 70/26, 70/26, 60/36, −122, so that the gear transitions of the various hub gearboxes together with the bottom bracket gearbox are approximately 23.9%, 19.5% and 16.4% for the 10-, 12- or 14-speed gearboxes.

13. The drive train of claims 9 to 11, characterized in that the number of teeth of the sun gear wheels and planetary gear wheels in the sequence from the input to the output comprises 52/41, 69/24 and 69/24 or 46/44, 63/27, 63/27 for a five-speed gearbox, wherein the ring gear wheel comprises −117 teeth respectively, and for a seven-speed gearbox 71/21, 61/30, 61/30 and 71/21 or 62/25, 52/35, 52/35 and 62/25, wherein the ring gear wheel comprises −122 teeth respectively, wherein no further higher-level shiftable gearbox is used, so that the gear transitions in the five-speed gearbox are 26.1% or 23.9% and the gear transitions in the seven-speed gearbox are 22.3% or 19.5%.

14. The drive train according to one or more of claims 8 to 13, characterized in that the gear shifting cable in the rear wheel hub rotationally acts on a gear shifting drum (ST) for gear adjustment, in which control grooves (N20, −N70) are provided, in which control fingers engage, which are arranged on axially slidable rings of the clutches (K20, −K70), wherein the same structures for shifting are arranged in the control grooves either twice, i.e. distributed by 180 degrees on the circumference, and accordingly a shift finger of a clutch engages in each of them, or all 2×N gears to be shifted are arranged at two times 120 degrees in the gear shifting drum and a further group of the shift grooves of the N gears are also arranged at the 3rd 120 degrees of the gear shifting drum circumference, wherein the control grooves are configured to be continuous and 3 shift fingers per clutch engage there respectively, so that all gears can be shifted with a 2/3 rotation of the gear shifting drum and the associated end positions of the shifting travel are limited in at least one further stop groove in which a fixed stop finger engages.
